(19) United States
(12) Patent Application Publication
(10) Pub. No.: US 2009/0263126 A1
(43) Pub. Date: Oct. 22, 2009

(54) MONITORING THE PHYSICAL LAYER OF OPTOELECTRONIC MODULES

(76) Inventors: Christina Woody Mercier, Hilo, HI (US); Greta L. Light, San Mateo, CA (US)

Correspondence Address: Workman Nydegger;1000 Eagle Gate Tower, 60 East South Temple, Salt Lake City, UT, 84111, US

(21) Appl. No.: 12/267,111

(22) Filed: Nov. 7, 2008

Related U.S. Application Data
(60) Provisional application No. 61/045,948, filed on Apr. 17, 2008.

(51) Int. Cl. H04B 10/08

(52) U.S. Cl. 398/33

(57) ABSTRACT

Monitoring the physical layer of optoelectronic modules in a storage area network (SAN). In one example embodiment, a method for monitoring the physical layer of optoelectronic modules in a storage area network includes various acts. First, diagnostic data is gathered from a plurality of optoelectronic modules. Next, the diagnostic data is automatically analyzed to determine that any of the plurality of optoelectronic modules is operating outside acceptable parameters. Finally, a solution is automatically formulated to bring the one or more malfunctioning optoelectronic modules back inside acceptable parameters.

### CROSS-REFERENCE TO A RELATED APPLICATION

The present application claims the benefit of U.S. Provisional Patent Application Ser. No. 61/045,948, filed Apr. 17, 2008 and entitled “MONITORING THE PHYSICAL LAYER OF ELECTRONIC MODULES,” which is incorporated herein by reference in its entirety.

### BACKGROUND

Optoelectronic modules, such as optoelectronic transceiver or transponder modules, are increasingly used in electronic and optoelectronic communication. Some modules can be plugged into a variety of host networking equipment. Multi-Source Agreements (“MSAs”) specify, among other things, package dimensions for modules. Conformity with an MSA allows a module to be plugged into host equipment designed in compliance with the MSA. Other modules are soldered to the printed circuit board of host networking equipment. Modules typically communicate with a printed circuit board of a host device by transmitting electrical signals to the printed circuit board and receiving electrical signals from the printed circuit board. These electrical signals can then be transmitted by the module outside the host device as optical and/or electrical signals.

One common difficulty associated with modules is accessing physical layer diagnostic data generated by the modules. Although a module may be configured to generate raw diagnostic data, it may be difficult for a user to determine whether the raw diagnostic data represents a module malfunction and/or what actions to take to correct a module malfunction.

### BRIEF SUMMARY OF SOME EXAMPLE EMBODIMENTS

Example embodiments of the present invention relate to monitoring the physical layer of optoelectronic modules, such as optoelectronic transceiver or transponder modules.

In a first example embodiment, a method for monitoring the physical layer of optoelectronic modules in a storage area network includes various acts. First, diagnostic data is gathered from a plurality of optoelectronic modules. Next, the diagnostic data is automatically analyzed to determine that any of the plurality of optoelectronic modules is operating outside acceptable parameters. Finally, a solution is automatically formulated to bring the one or more malfunctioning optoelectronic modules back inside acceptable parameters.

In a second example embodiment, a method for monitoring the physical layer of optoelectronic modules in a storage area network includes various acts. First, first diagnostic data is gathered from a first optoelectronic module. Next, second diagnostic data is gathered from a second optoelectronic module. Then, the first and second diagnostic data is automatically analyzed to determine that one or both of the first and second optoelectronic modules are operating outside acceptable parameters. Next, the first and second diagnostic data is correlated. Finally, a solution based on the correlation is automatically formulated to bring the one or both malfunctioning optoelectronic modules back inside acceptable parameters.

In a third example embodiment, a computer program product includes one or more computer-readable media having thereon computer-executable instructions that, when executed by one or more processors of a computer, causes the computer to perform the first example method for monitoring the physical layer of optoelectronic modules in a storage area network.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

To further clarify certain aspects of example embodiments of the invention, a more particular description of the invention will be rendered by reference to example embodiments thereof which are disclosed in the appended drawings. It is appreciated that these drawings depict only example embodiments of the invention and are therefore not to be considered limiting of its scope nor are they necessarily drawn to scale. Aspects of example embodiments of the invention will be described and explained with additional specificity and detail through the use of the accompanying drawings in which:

FIG. 1 is a schematic diagram of an example storage area network;

FIG. 2 is a schematic diagram of an example host device, an example switch, and an example storage device; and

FIG. 3 is a flowchart of an example method for monitoring the physical layer of optoelectronic modules in a storage area network.

### DETAILED DESCRIPTION OF SOME EXAMPLE EMBODIMENTS

In the following detailed description of the embodiments, reference will now be made in detail to specific embodiments of the present invention, examples of which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

Example embodiments of the present invention relate to monitoring the physical layer of optoelectronic modules, such as optoelectronic transceiver or transponder modules, in a storage area network.

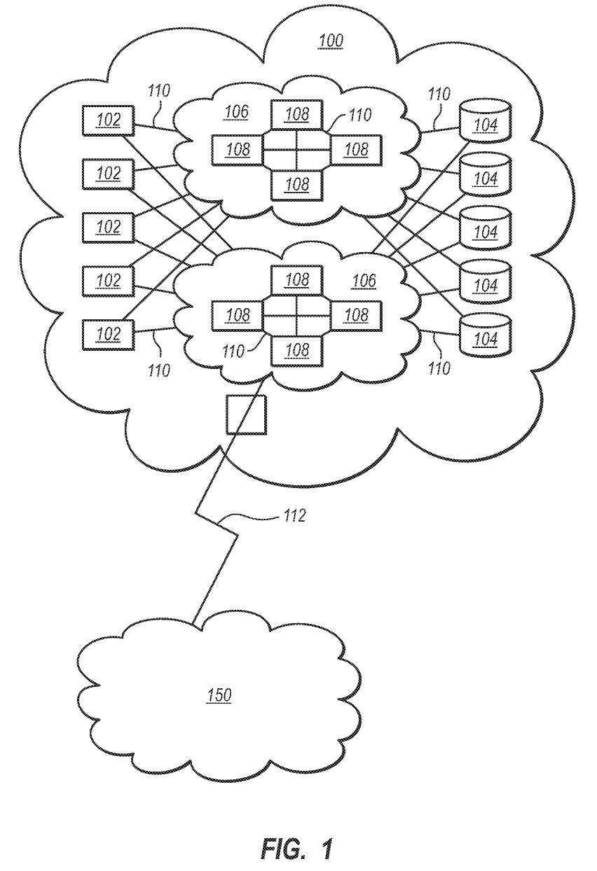

With reference now to FIG. 1, an example storage area network (SAN) 100 is disclosed. As disclosed in FIG. 1, the example SAN 100 includes multiple host devices 102, multiple storage devices 104, and a pair of switch fabrics 106. The switch fabrics 106 include multiple switches 108. The switches 108 enable a particular host device 102 to be dynamically connected to a particular storage device 104 via two or more data communication lines 110. The data communication lines 110 can be, for example, single-fiber or multi-fiber fiber-optic cables.

As disclosed in FIG. 1, the example SAN 100 is also connected to a second SAN 150 via one or more long-distance data communication lines 112.

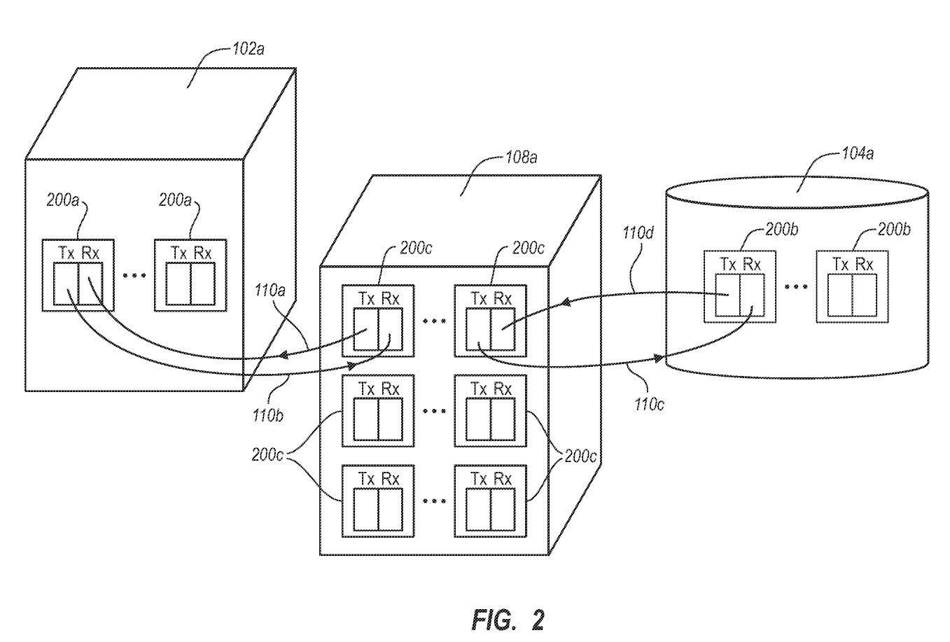

With reference now to FIG. 2, an example host device 102a, an example storage device 104a, and an example switch 108a are disclosed. As disclosed in FIG. 2, the host device 102a includes a pair of optoelectronic modules 200a. Similarly, the storage device 104a includes multiple optoelectronic modules 200b, and the switch 108a includes multiple optoelectronic modules 200c.

The optoelectronic modules discussed herein can be configured for optical signal transmission and reception at a variety of per-second data rates including, but not limited to, 1 Gbit, 2 Gbit, 2.5 Gbit, 4 Gbit, 8 Gbit, 10 Gbit, 10.3 Gbit, 10.5 Gbit, or higher. Further, the optoelectronic modules can be configured for optical signal transmission and reception at various wavelengths including, but not limited to, 850 nm, 1310 nm, 1470 nm, 1490 nm, 1510 nm, 1530 nm, 1550 nm, 1570 nm, 1590 nm, or 1610 nm. Also, the optoelectronic modules can be configured to support various communication protocols including, but not limited to, Fast Ethernet, Gigabit Ethernet, 10 Gigabit Ethernet, and 1×, 2×, 4×, and 10× Fibre Channel. Further, the optoelectronic modules can be configured to operate at various temperature ranges including, but not limited to, 0° C. to 70° C. In addition, the optoelectronic modules can be configured to assume a variety of different form factors that are substantially compliant with various optoelectronic transceiver and/or transponder MSAs including, but not limited to, SFP, SFP+, SFF, GBIC, PON, XFP, XPAK, X2, XENPAK, or 300-PIN.

The host device 102a is connected to the switch 108a via a pair of data communication lines 110a and 110b. The switch 108a is connected to the storage device 104a via another pair of data communication lines 110c and 110d.

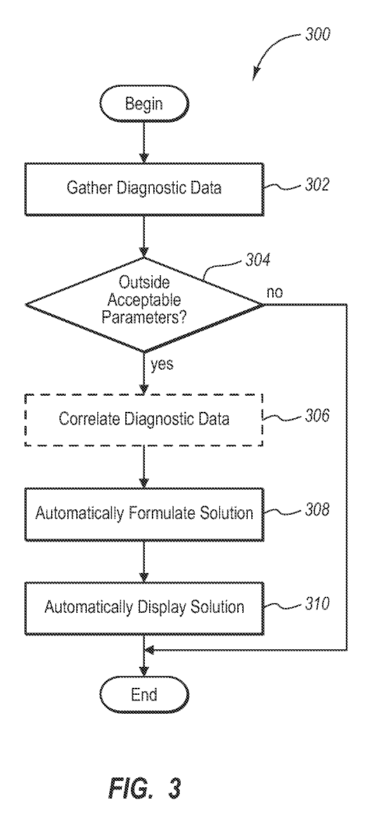

With reference now to FIG. 3, a flowchart of an example method 300 for monitoring the physical layer of optoelectronic modules in a storage area network is disclosed.

As disclosed in FIG. 3, the example method 300 includes various acts. First, at act 302, diagnostic data is gathered from a plurality of optoelectronic modules. Next, at act 304, the diagnostic data is automatically analyzed to determine whether any of the plurality of optoelectronic modules is operating outside acceptable parameters.

If it is determined at act 304 that one or more of the plurality of optoelectronic modules is operating outside acceptable parameters. Then the method 300 proceeds to optional act 306 where the diagnostic data is correlated. Next, at act 308 a solution is automatically formulated to bring the one or more malfunctioning optoelectronic modules back inside acceptable parameters. Then, at act 310 the solution is automatically displayed on a user interface, at which point the method 300 terminates.

If, however, it is determined at act 304 that one or more of the plurality of optoelectronic modules is not operating outside acceptable parameters, then the method 300 terminates.

An example implementation of the example method 300 will now be disclosed in connection with FIG. 2. The various acts in the example implementation of the method 300 can be performed, for example, by software running on a computer (not shown) that is in communication with one or more of the devices 102a, 104a, and 108a. The software may include computer-executable instructions that can be executed by the processor(s) of the computer. These computer-executable instructions or data structures may be present on one or more computer-readable media of the type described herein.

Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Computers are now increasingly taking a wide variety of forms. Computers may, for example, be handheld devices, appliances, laptop computers, desktop computers, mainframes, distributed computers, or even devices that have not been conventionally considered a computer. In this description and in the claims, the term “computer” is defined broadly as including any device or system (or combination thereof) that includes at least one processor, and a memory capable of having thereon computer-executable instructions that may be executed by the processor. The memory may take any form and may depend on the nature and form of the computer. A computer may be distributed over a network environment and may include multiple constituent computers.

In the example implementation, at act 302, diagnostic data is gathered from the optoelectronic modules 200a, 200b, and 200c. Diagnostic data can be available from each of the optoelectronic modules 200a, 200b, and 200c via a serial bus address accessible by a device driver on the corresponding device into which the optoelectronic module is positioned.

The diagnostic data gathered at act 302 may include, for example, measurements of transmitter output power, receiver sensitivity, laser bias current, transceiver input voltage, transceiver temperature, or some combination thereof Monitoring the transmitter output power can be useful because a laser within the transmitter (Tx) of an optoelectronic module must operate within a power budget in order to avoid data corruption. The transmitter output power can be monitored in order to identify a loss of signal and to set a fault (LOS). The transmitter output power may also be monitored in order to identify power levels that are indicative of the optoelectronic module operating in a danger zone. The transmitter output power may further be monitored to identify situations where excessively high power levels are present given the relatively short distance of the data communication lines connected to the transmitter. Monitoring the transceiver temperature can be useful because where the optics temperature is out of the best operating band, it will degrade the life of the module. This might happen in an insufficiently cooled computer room, for example. Monitoring the transceiver input voltage can be useful because if the voltage is out of the best operating band then the power supply may be a problem and may indicate that the power supply is failing. Monitoring the laser bias current can be useful because trending the laser's bias current can show proactive failure of a laser as the current slowly recedes.

Next, at act 304, the diagnostic data is automatically analyzed to determine whether any of the plurality of optoelectronic modules 200a, 200b, and/or 200c are operating outside acceptable parameters.

If it is determined at act 304 that one or more of the plurality of optoelectronic modules is operating outside acceptable parameters, then the method 300 may proceed to optional act 306 where the diagnostic data is correlated. In some example embodiments, correlating the diagnostic data includes comparing and contrasting diagnostic data from two or more optoelectronic modules. For example, diagnostic data from the optoelectronic module 200a and the optoelectronic module 200c at either end of the communication cable 110a can be compared and contrasted.

As disclosed in FIG. 1, the act 306 enables the extrapolation of the analysis of the optoelectronic modules diagnostics to the functioning of the SAN 100. By correlating multiple optoelectronic modules along the data path between one of the host devices 102 and one of the storage devices 104, it can be determined that a link with one or more failing or failed optoelectronic modules has made the entire SAN data path unsafe for data transmission due to the optoelectronic modules operating out of compliance.

Next, at act 308, and with reference again to FIG. 2, a solution is automatically formulated to bring the one or more malfunctioning optoelectronic modules 200a, 200b, and/or 200c back inside acceptable parameters. Where the diagnostic data has been correlated at act 306, the solution may be based on the correlation. For example, in the case of a data path being determined unsafe at act 306, the data stream could be moved to an alternate path since each host device 102 disclosed in FIG. 1 has access to each storage device 104 via multiple paths in the SAN 100.

In some example embodiments, automatically formulating a solution to bring the one or more malfunctioning optoelectronic modules 200a, 200b, and/or 200c back inside acceptable parameters further includes combining the diagnostic data with additional characteristics of the plurality of optoelectronic modules 200a, 200b, and/or 200c and automatically formulating a solution based on the combination. For example, the additional characteristics may include the length of the data communication line 110a that connects the optoelectronic module 200a to the optoelectronic module 200c, the ambient temperature of the room in which one or more of the optoelectronic modules 200a, 200b, and 200c is positioned, a power level of a power supply to which one or more of the optoelectronic modules 200a, 200b, and 200c are connected, or some combination thereof For example, where the current power level for the optoelectronic module 200a and/or the optoelectronic module 200c is more than required for the relatively short length of the data communication line 110a, the automatically formulated solution may include dialing down the power level of the module(s).

The additional characteristics may further include the following information about an individual optoelectronic module: module type, vendor name, part number, laser wavelength, external connector type, or some combination thereof. At least a portion of the additional characteristics may be received from a user via a user interface of the software discussed above. Further, at least a portion of the additional characteristics may be automatically acquired without input from a user interface. For example, the length of the data communication line 110a may be input by a user via a user interface, while the power level of a power supply to which one or more of the optoelectronic modules 200a, 200b, and 200c are connected and the ambient temperature of the room in which one or more of the optoelectronic modules 200a, 200b, and 200c is positioned may be automatically acquired without input from the user via the user interface.

At act 310 the solution is automatically displayed on a user interface. The user interface may be the user interface of the software discussed above. From a user interface perspective, data paths within the SAN 100 could be shown as “within compliance,” “degraded but working,” or “unsafe due to the optoelectronic modules being out of compliance.” In cases where the optoelectronic modules cannot be reconfigured to be in compliance, the user interface may provide a location of the malfunctioning optoelectronic module to assist the user in its replacement, or other specific instructions can be provided on the user interface. These specific instructions may include instructions to replace a specific power supply that is powering the malfunctioning optoelectronic module, to adjust the temperature by a certain amount in the room where the malfunctioning optoelectronic module is positioned, or to adjust the length of one or more of the data communication lines connected to the malfunctioning optoelectronic module.

This example implementation of the method 300 thus enables a user to be automatically alerted to a malfunction in one or more of the optoelectronic modules 200a, 200b, and 200c and be advised as to a solution to bring the one or more malfunctioning optoelectronic modules 200a, 200b, and 200c back inside acceptable parameters. This allows dynamic tracking of the health and operation of the physical layer within a SAN, such as the SAN 100. Obtaining the diagnostics from every optoelectronic module in the SAN enables full monitoring of the physical layer. With diagnostics from both TX and RX sides, the power budget (beginning power—ending power) can be dynamically tracked and the health of every optoelectronic module in the SAN can be monitored.

The example embodiments disclosed herein may be embodied in other specific forms. The example embodiments disclosed herein are to be considered in all respects only as illustrative and not restrictive.

What is claimed is:

1. A method for monitoring the physical layer of optoelectronic modules in a storage area network, the method comprising:
gathering diagnostic data from a plurality of optoelectronic modules;
automatically analyzing the diagnostic data to determine that any of the plurality of optoelectronic modules is operating outside acceptable parameters;
automatically formulating a solution to bring the one or more malfunctioning optoelectronic modules back inside acceptable parameters.

2. The method as recited in claim 1, wherein automatically formulating a solution to bring the one or more malfunctioning optoelectronic modules back inside acceptable parameters further comprises combining the diagnostic data with additional characteristics of the plurality of optoelectronic modules and automatically formulating a solution based on the combination to bring the one or more malfunctioning optoelectronic modules back inside acceptable parameters.

3. The method as recited in claim 2, wherein the additional characteristics comprise the distance of an optical fiber connecting two of the optoelectronic modules, the ambient temperature of the room in which one or more of the optoelectronic modules is positioned, a power level of a power supply to which one or more of the optoelectronic modules are connected, or some combination thereof.

4. The method as recited in claim 2, wherein at least a portion of the additional characteristics are received from a user interface.

5. The method as recited in claim 2, wherein at least a portion of the additional characteristics are automatically acquired without input from a user interface.

6. The method as recited in claim 1, wherein the diagnostic data comprises measurements of transmitter output power, receiver sensitivity, laser bias current, transceiver input voltage, transceiver temperature, or some combination thereof.

7. The method as recited in claim 1, further comprising automatically displaying the solution on a user interface.

8. The method as recited in claim 1, wherein each of the optoelectronic modules is substantially compliant with one of the following MSAs: SFP, SFP+, SFF, GBIC, PON, XFP, XPAK, X2, XENPAK, or 300-PIN.

9. The method as recited in claim 1, wherein the plurality of optoelectronic modules each operate in one of a host device, a switch device, or a storage device.

10. A method for monitoring the physical layer of optoelectronic modules in a storage area network, the method comprising:
gathering first diagnostic data from a first optoelectronic module;
gathering second diagnostic data from a second optoelectronic module;
automatically analyzing the first and second diagnostic data to determine that one or both of the first and second optoelectronic modules are operating outside acceptable parameters;
correlating the first and second diagnostic data; and
automatically formulating a solution based on the correlation to bring the one or both malfunctioning optoelectronic modules back inside acceptable parameters.

11. The method as recited in claim 10, wherein automatically formulating a solution based on the correlation to bring the one or more malfunctioning optoelectronic modules back inside acceptable parameters further comprises combining the first and second diagnostic data with additional characteristics of one or both of the first and second optoelectronic modules and automatically formulating a solution based on the correlation and the combination to bring the one or both of the malfunctioning optoelectronic modules back inside acceptable parameters.

12. The method as recited in claim 11, wherein the additional characteristics comprise the distance of an optical fiber connecting the first and second optoelectronic modules, the ambient temperature of the room in which one or both of the first and second optoelectronic modules are positioned, a power level of a power supply to which one or both of the optoelectronic modules are connected, or some combination thereof.

13. The method as recited in claim 11, wherein at least a portion of the additional characteristics are received from a user interface.

14. The method as recited in claim 11, wherein at least a portion of the additional characteristics are automatically acquired without input from a user interface.

15. The method as recited in claim 10, wherein the diagnostic data comprises measurements of transmitter output power, receiver sensitivity, laser bias current, transceiver input voltage, transceiver temperature, or some combination thereof.

16. The method as recited in claim 10, wherein each of the first and >>¢ >>>second optoelectronic modules is substantially compliant with one of the following MSAs: SFP, SFP+, SFF, GBIC, PON, XFP, XPAK, X2, XENPAK, or 300-PIN.

17. The method as recited in claim 10, wherein each of the first and second optoelectronic modules operates in one of a host device, a switch device, or a storage device.

18. A computer program product comprising one or more computer-readable media having thereon computer-executable instructions that, when executed by one or more processors of a computer, causes the computer to perform a method for monitoring the physical layer of optoelectronic modules in a storage area network, the method comprising:
gathering diagnostic data from a plurality of optoelectronic modules;
automatically analyzing the diagnostic data to determine that any of the plurality of optoelectronic modules is operating outside acceptable parameters;
automatically formulating a solution to bring the one or more malfunctioning optoelectronic modules back inside acceptable parameters.

19. The computer program product as recited in claim 18, wherein automatically formulating a solution to bring the one or more malfunctioning optoelectronic modules back inside acceptable parameters further comprises combining the diagnostic data with additional characteristics of the plurality of optoelectronic modules and automatically formulating a solution based on the combination to bring the one or more malfunctioning optoelectronic modules back inside acceptable parameters.

20. The computer program product as recited in claim 19, wherein the additional characteristics comprise the distance of an optical fiber connecting two of the optoelectronic modules, the ambient temperature of the room in which one or more of the optoelectronic modules is positioned, a power level of a power supply to which one or more of the optoelectronic modules are connected, or some combination thereof.
